(19) United States
(12) Patent Application Publication
(10) Pub. No.: US 2025/0388277 A1
(43) Pub. Date: Dec. 25, 2025

(54) OVERMOLDING CONFIGURATION FOR A SPARE TIRE CARRIER ASSEMBLY OF A MOTOR VEHICLE

(71) Applicant: Ford Global Technologies, LLC, Dearborn, MI (US)

(72) Inventor: Joseph Prior, Detroit, MI (US)

(21) Appl. No.: 18/753,305

(22) Filed: Jun. 25, 2024

(51) Int. Cl. B62D 43/02

(52) U.S. Cl. CPC B62D 43/02

(57) ABSTRACT

A spare tire carrier assembly may include a metallic frame including a first side and a second side opposite the first side, wherein the metallic frame includes a bore passing through the metallic frame from the first side to the second side. A spare tire carrier assembly may include an overmolding including a first portion molded over at least a portion of the first side, and a second portion molded over at least a portion of the frame that establishes the bore.

### TECHNICAL FIELD

This disclosure relates to an overmolding configuration for a spare tire carrier assembly of a motor vehicle.

### BACKGROUND

Wheel assemblies for motor vehicles include wheels and tires. Motor vehicles are known to include spare wheel assemblies. Spare wheel assemblies are often referred to colloquially as spare tires. Spare wheel assemblies are known to be carried within an interior of a motor vehicle, such as being stored in a trunk or cargo area of the motor vehicle. Spare wheel assemblies may alternatively or additionally be mounted to an exterior of the motor vehicle, such as being supported relative to a side, rear, or bottom of the motor vehicle via a spare tire carrier assembly.

### SUMMARY

In some aspects, the techniques described herein relate to a spare tire carrier assembly, including: a metallic frame including a first side and a second side opposite the first side, wherein the metallic frame includes a bore passing through the metallic frame from the first side to the second side; and an overmolding including a first portion molded over at least a portion of the first side, and a second portion molded over at least a portion of the frame that establishes the bore.

In some aspects, the techniques described herein relate to an assembly, wherein a diameter of the bore is not constant along a length of the bore.

In some aspects, the techniques described herein relate to an assembly, wherein: the bore includes a first opening adjacent the first side of the metallic frame and a second opening adjacent the second side of the metallic frame, the bore exhibits a first diameter adjacent the first opening and a second diameter adjacent the second opening, and the second diameter is greater than the first diameter.

In some aspects, the techniques described herein relate to an assembly, wherein the second portion of the overmolding projects into the bore and extends along an entire length of the bore from the first opening to the second opening.

In some aspects, the techniques described herein relate to an assembly, wherein the second portion does not extend to the second side of the frame.

In some aspects, the techniques described herein relate to an assembly, wherein, when the assembly is mounted to a body panel of a motor vehicle, the second opening is closer to the body panel than the first opening.

In some aspects, the techniques described herein relate to an assembly, wherein: the bore includes a first section extending along a first portion of a length of the bore from the first opening to an intermediate point, and the bore exhibits the first diameter along an entirety of the first section.

In some aspects, the techniques described herein relate to an assembly, wherein the bore is substantially cylindrically-shaped throughout an entirety of the first section.

In some aspects, the techniques described herein relate to an assembly, wherein: the bore includes a second section extending along a second portion of the length of the bore from the intermediate point to the second opening, and the bore exhibits a diameter greater than the first diameter throughout an entirety of the second section.

In some aspects, the techniques described herein relate to an assembly, wherein: the bore exhibits the second diameter adjacent the second opening, and the diameter of the bore gradually transitions from the first diameter to the second diameter between the intermediate point and the second opening.

In some aspects, the techniques described herein relate to an assembly, wherein the bore is substantially frustoconically-shaped within the second section.

In some aspects, the techniques described herein relate to an assembly, further including a threaded stud projecting through the bore from the second side of the frame and extending beyond the first side of the frame.

In some aspects, the techniques described herein relate to an assembly, wherein: the bore is one of a plurality of bores of the frame, the overmolding includes a plurality of second portions, and each of the second portions are molded over at least a portion of the frame that establishes a respective one of the plurality of bores.

In some aspects, the techniques described herein relate to an assembly, wherein the first portion of the overmolding is molded over substantially an entirety of the first side of the metallic frame.

In some aspects, the techniques described herein relate to a motor vehicle, including: a body panel; and a spare tire carrier assembly mounted to the body panel, wherein the spare tire carrier assembly includes: a metallic frame including a first side and a second side opposite the first side, wherein the metallic frame includes a bore passing through the metallic frame from the first side to the second side; and an overmolding including a first portion molded over at least a portion of the first side, and a second portion molded over at least a portion of the bore.

In some aspects, the techniques described herein relate to a motor vehicle, wherein the body panel is configured to open and close relative to a rear opening of the motor vehicle.

In some aspects, the techniques described herein relate to a motor vehicle, wherein the body panel is a panel of a swing gate.

In some aspects, the techniques described herein relate to a motor vehicle, wherein: the bore includes a first opening adjacent the first side of the metallic frame and a second opening adjacent the second side of the metallic frame, the bore exhibits a first diameter adjacent the first opening and a second diameter adjacent the second opening, and the second diameter is greater than the first diameter.

In some aspects, the techniques described herein relate to a motor vehicle, wherein the second portion of the overmolding projects into the bore and extends along an entire length of the bore from the first opening to the second opening.

In some aspects, the techniques described herein relate to a method, including: overmolding a metallic frame of a spare tire carrier assembly, wherein the metallic frame includes a first side and a second side opposite the first side, wherein the metallic frame further includes a bore passing through the metallic frame from the first side to the second side, and wherein the overmolding includes a first portion molded over at least a portion of the first side, and a second portion molded over at least a portion of the metallic frame establishing the bore.

### BRIEF DESCRIPTION OF THE DRAWINGS

FIG. 1 is a rear perspective view of a portion of a motor vehicle with a spare tire carrier assembly.

FIG. 2 is a view similar to FIG. 1, with a wheel assembly supported on the spare tire carrier assembly.

FIG. 3 is an exploded, perspective view of an example spare tire carrier assembly.

FIG. 4 is an assembled view of the example spare tire carrier assembly.

FIG. 5 is a cross-sectional view of a portion of the spare tire carrier assembly, and in particular illustrates an example stud mount arrangement.

FIG. 6 is a cross-sectional view of a portion of the spare tire carrier assembly, and in particular illustrates a configuration of an example bore of a frame of the spare tire carrier assembly with the overmolding removed.

FIG. 7 is a view similar to FIG. 6 with the overmolding present.

### DETAILED DESCRIPTION

This disclosure relates to an overmolding configuration for a spare tire carrier assembly of a motor vehicle. Among other benefits, the disclosed arrangement resists separation of an overmolding from a metallic frame.

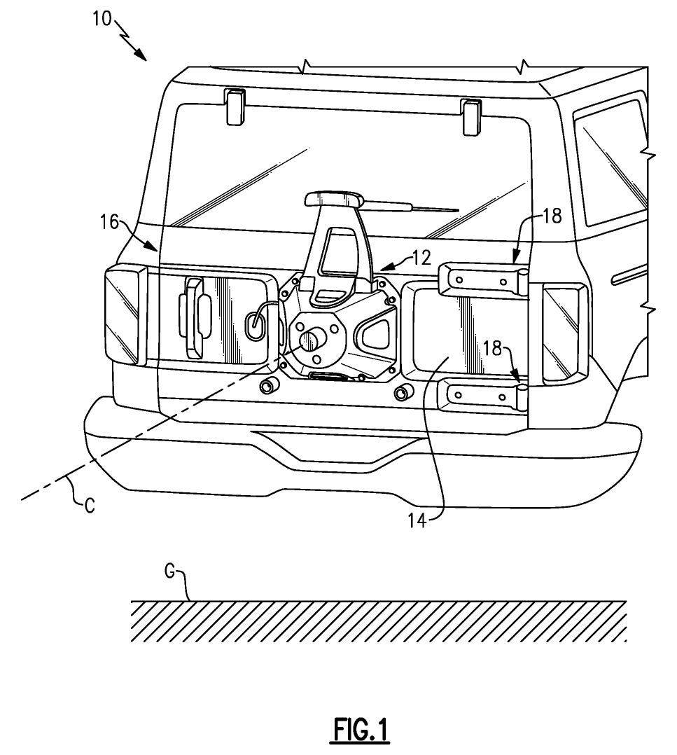

FIG. 1 illustrates a portion of a motor vehicle 10 (“vehicle 10”) from a rear perspective. In FIG. 1, the vehicle 10 is a sport utility vehicle (SUV). While an SUV is shown, this disclosure extends to other vehicle types, including trucks, sedans, vans, etc.

The vehicle 10 includes a spare tire carrier assembly 12 (“assembly 12”). The assembly 12 is mounted to a panel 14 of a body of the vehicle 10. In this example, the panel 14 provides a rear panel of the vehicle 10, and in particular provides a rear panel of a swing gate 16 of the vehicle 10. The swing gate 16 is configured to selectively open and close by rotating, or swinging, relative to an opening in the rear of the vehicle 10 via hinge assemblies 18 mounted adjacent a side of the swing gate 16. While a swing gate 16 is shown in FIG. 1, this disclosure extends to spare tire carrier assemblies that are not mounted to a swing gate, and are instead mounted to another part of the vehicle. Further, while a spare tire carrier assembly is shown and described, this disclosure could be applied to other vehicle assemblies.

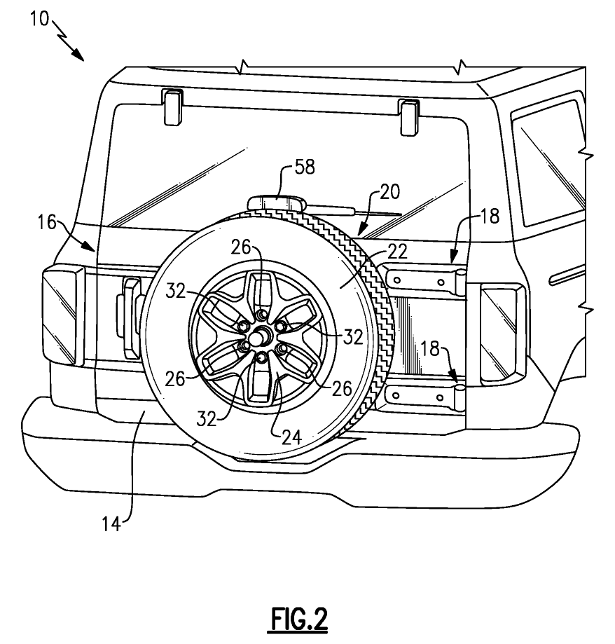

FIG. 2 illustrates a wheel assembly 20 supported on the assembly 12. The wheel assembly 20 includes a tire 22 and a hub 24 with lug holes 26. Here, the hub 24 includes six lug holes 26. This disclosure extends to wheel assemblies with a different number of lug holes 26.

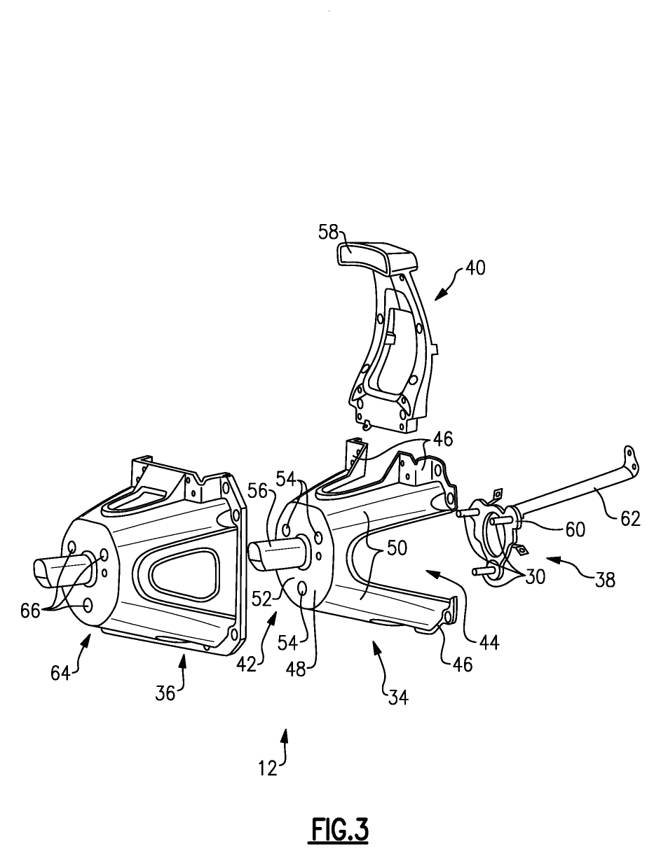

The assembly 12 includes a plurality of threaded studs 30 (FIG. 3) configured to project through the lug holes 26. The threaded studs 30 are configured to interface with nuts 32 to hold the wheel assembly 20 in place relative to the assembly 12 and, in turn, the vehicle 10. A user can selectively remove the nuts 32 from the threaded studs 30 to remove the wheel assembly 20 from the assembly 12. While there are three threaded studs 30 and three nuts 32 engaged with those threaded studs 30, this disclosure extends to other quantities of threaded studs 30 and nuts 32.

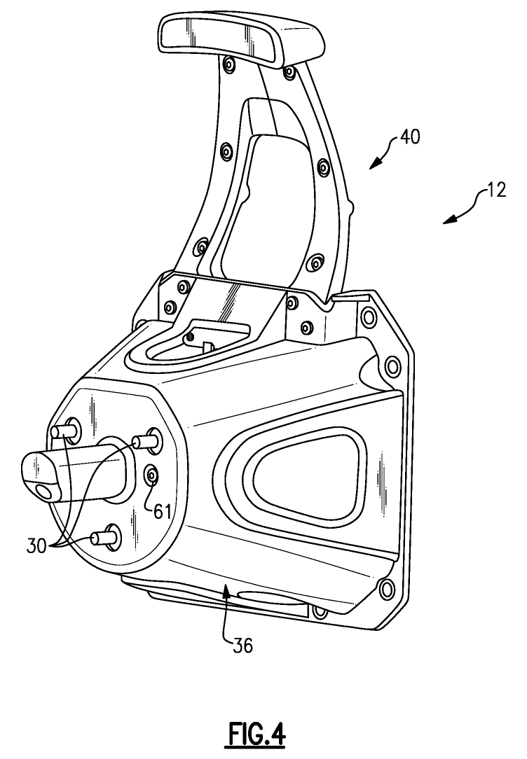

FIG. 3 is an exploded, perspective view of the assembly 12. FIG. 4 is an assembled view of the assembly 12. With joint reference to FIGS. 3 and 4, the assembly 12 includes a frame 34, an overmolding 36, a stud support 38, and a lamp support 40.

The frame 34 is made of a metallic material in this example, and may be referred to as a metallic frame. The frame 34 may be formed by stamping, for example. In a particular example, the frame 34 is entirely made of a single, integrally-formed piece of metal. In an even further example, the frame 34 is made of magnesium. The frame includes a first side 42 facing away from panel 14 and a second side 44 facing toward panel 14.

The frame 34 further includes a panel-mounting portion 46 configured to facilitate attachment of the frame 34 to the panel 14, and a wheel-mounting portion 48 spaced-apart from the panel-mounting portion 46 via a plurality of legs 50. The panel-mounting portion 46 includes a plurality of sections at ends of the plurality of legs 50 configured to facilitate attachment to the panel 14. The panel-mounting portion 46 includes openings configured to receive fasteners, in one example.

The wheel-mounting portion 48 includes a wall 52. When mounted to the vehicle 10, the wall 52 is substantially perpendicular to a centerline C of the vehicle 10 and perpendicular to a ground surface G adjacent the vehicle 10. The wall 52 includes three bores 54 configured to permit the threaded studs 30 to project therethrough. In this example, a camera mount 56 projects rearward from the wall 52. The camera mount 56 supports a rear backup camera in one example. The camera mount 56 is not present in all examples.

Adjacent a top of the frame 34, the frame 34 is configured to support the lamp support 40. The lamp support 40 projects vertically upward from the frame 34 and supports a conspicuity lamp 58 of the vehicle 10 above a top of the wheel assembly 20 when the wheel assembly 20 is supported by the assembly 12. The conspicuity lamp 58 may be a center high-mounted stop lamp (CHMSL) of the vehicle 10.

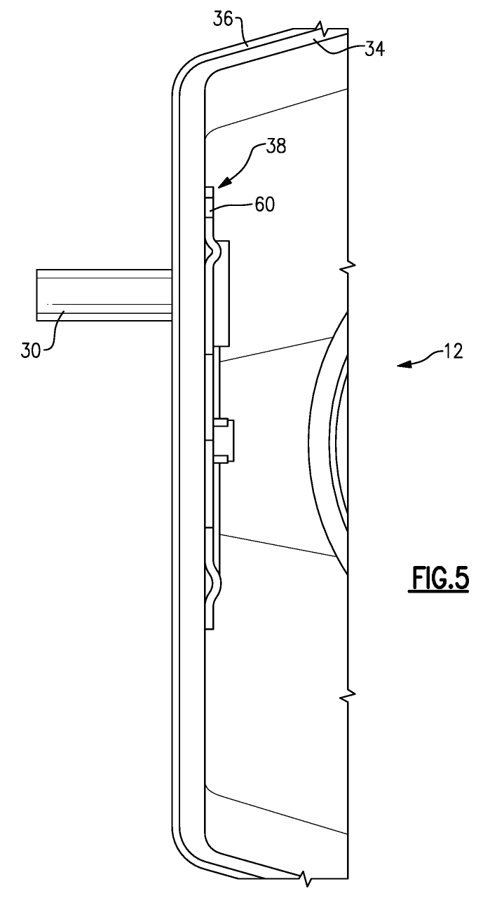

The stud support 38 includes a ring 60, which may be made of a metallic material, and three threaded studs 30 projecting therefrom. The ring 60 may be fastened to the frame 34 via fastener 61 (FIG. 4), for example. The ring 60 may also be supported relative to the panel 14 via a bracket 62 projecting from the ring 60. Stud support 38 supports the threaded studs 30 such that the threaded studs 30 project through bores 54, and such that the threaded studs 30 are able to interface with nuts 32 when a wheel assembly 20 is arranged relative to assembly 12, as generally shown in FIG. 5.

The overmolding 36 is formed by material that is molded over the frame 34. In this respect, the overmolding 36 may be deemed to be a part of the frame 34. For description purposes, the overmolding 36, in this disclosure, refers to the portion of the frame 34 that was formed by being molded over the metallic material of the frame 34. The overmolding 36, in one example, is a thermoplastic material. In a specific example, the overmolding is made of a nylon material.

In this example, the overmolding 36 includes a first portion 64 molded over at least a portion of the first side 42 of the frame 34. In a particular example, the first portion 64 of the overmolding 36 covers substantially the entire first side 42, including the first side 42 of the panel-mounting portion 46, the wheel-mounting portion 48, the legs 50, and the camera mount 56 (if present). The overmolding 36 also includes at least one second portion 66, which is molded over at least a portion of the frame 34 that establishes the bores 54. The second portion 66 extends at least partially into the bore 54. In this example, there are three second portions 66.

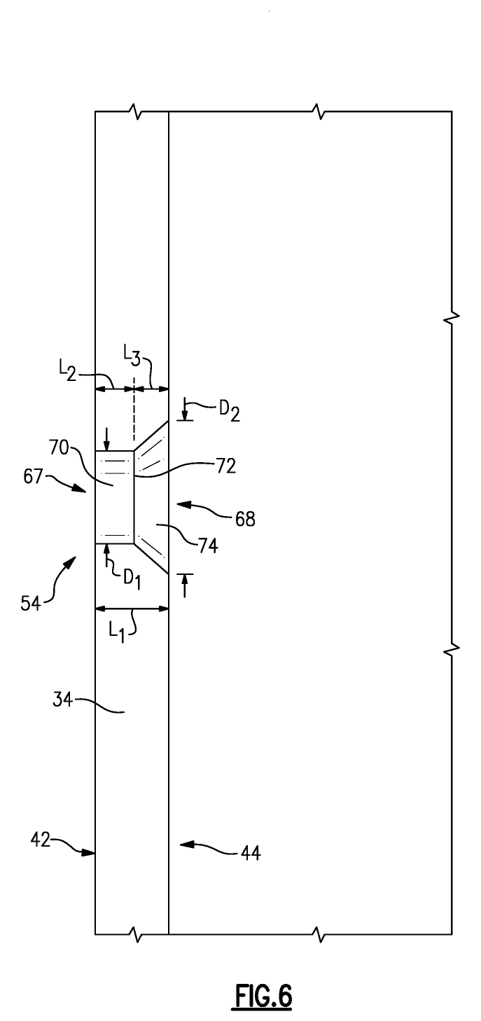

FIG. 6 illustrates an example configuration of one of the bores 54 without the overmolding 36. While only one bore 54 is shown, the other bores 54 are arranged similarly. The bore 54 includes a length L1 between first opening 67, which is adjacent the first side 42 of the frame 34, and a second opening 68, which is adjacent the second side 44 of the frame 34. Length L1 is equal to a thickness of frame 34, making the bore 54 a through-bore extending through an entirety of the thickness of the frame 34 and connecting the first and second sides 42, 44. A diameter of the bore 54 is not constant along the length L1. Rather, in this example, the bore 54 exhibits a first diameter D1 adjacent the first opening 67 and a second diameter D2 adjacent the second opening 68. The second diameter D2 is greater than the first diameter D1.

The bore 54 includes a first section 70 extending along a first portion L2 of length L1 from the first opening 67 to an intermediate point 72, which is a point between the first and second openings 67, 68. In this example, the bore 54 exhibits the first diameter D1 along an entirety of the first section 70. Further, in this example, the bore 54 is substantially cylindrically-shaped throughout the entirety of the first section 70.

The bore 54 further includes a second section 74 extending along a second portion L3 of the length L1 from the intermediate point 72 to the second opening 68. In this example, the bore 54 exhibits a diameter greater than the first diameter D1 throughout an entirety of the second section 74. Specifically, beginning at the intermediate point 72 and moving toward the second opening 68, the diameter of the bore 54 gradually transitions, and in particular gradually increases such that the bore 54 gradually widens, from the first diameter D1 to the second diameter D2. In this way, the bore 54 is substantially frustoconically-shaped within the second section 74.

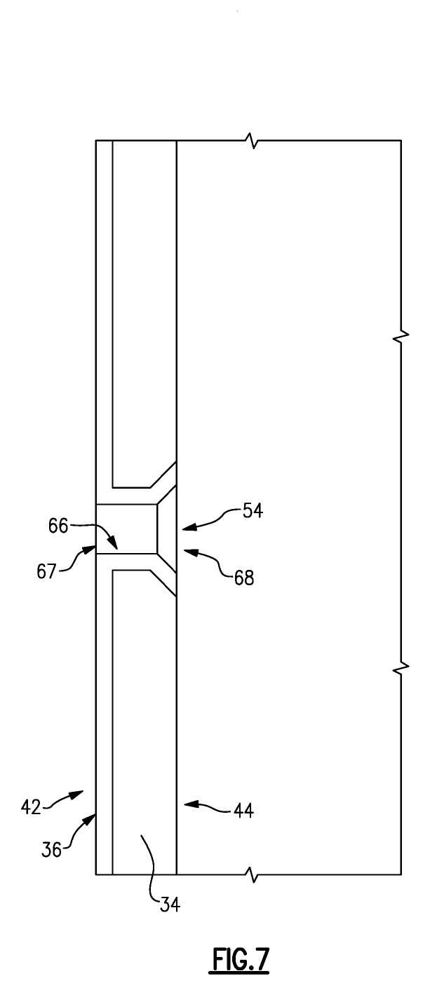

FIG. 7 illustrates the overmolding 36 relative to the bore 54. Specifically, a second portion 66 of the overmolding 36 projects into the bore 54 and is molded over at least a portion of the frame 34 establishing the bore 54. The second portion 66, in this example, projects into the bore 54 and extends along an entire length of the bore 54 from the first opening 67 to the second opening 68. In this example, the second portion 66 does not extend to the second side 44 of the frame 34.

Because of the arrangement of the bore 54 and the corresponding arrangement of the overmolding 36, and specifically because overmolding 36 is present on the portion of the bore 54 providing the second section 74, detachment of the overmolding 36 from the frame 34 is resisted.

It should be understood that directional terms such as “bottom,” “top,” “forward,” “rearward,” “upward,” “downward,” etc., are used for purposes of explanation only and should not be deemed limiting. Further, it should be understood that terms such as “about,” “substantially,” and “generally” are not intended to be boundaryless terms, and should be interpreted consistent with the way one skilled in the art would interpret those terms. It should be understood that certain aspects of the disclosure are exaggerated in the Figures for purposes of illustration only.

Although the different examples have the specific components shown in the illustrations, embodiments of this disclosure are not limited to those particular combinations. It is possible to use some of the components or features from one of the examples in combination with features or components from another one of the examples.

One of ordinary skill in this art would understand that the above-described embodiments are exemplary and non-limiting. That is, modifications of this disclosure would come within the scope of the claims. Accordingly, the following claims should be studied to determine their true scope and content.

1. A spare tire carrier assembly, comprising:
a metallic frame including a first side and a second side opposite the first side, wherein the metallic frame includes a bore passing through the metallic frame from the first side to the second side; and
an overmolding including a first portion molded over at least a portion of the first side, and a second portion molded over at least a portion of the frame that establishes the bore.

2. The assembly as recited in claim 1, wherein a diameter of the bore is not constant along a length of the bore.

3. The assembly as recited in claim 2, wherein:
the bore includes a first opening adjacent the first side of the metallic frame and a second opening adjacent the second side of the metallic frame,
the bore exhibits a first diameter adjacent the first opening and a second diameter adjacent the second opening, and
the second diameter is greater than the first diameter.

4. The assembly as recited in claim 3, wherein the second portion of the overmolding projects into the bore and extends along an entire length of the bore from the first opening to the second opening.

5. The assembly as recited in claim 4, wherein the second portion does not extend to the second side of the frame.

6. The assembly as recited in claim 3, wherein, when the assembly is mounted to a body panel of a motor vehicle, the second opening is closer to the body panel than the first opening.

7. The assembly as recited in claim 3, wherein:
the bore includes a first section extending along a first portion of a length of the bore from the first opening to an intermediate point, and
the bore exhibits the first diameter along an entirety of the first section.

8. The assembly as recited in claim 7, wherein the bore is substantially cylindrically-shaped throughout an entirety of the first section.

9. The assembly as recited in claim 7, wherein:
the bore includes a second section extending along a second portion of the length of the bore from the intermediate point to the second opening, and
the bore exhibits a diameter greater than the first diameter throughout an entirety of the second section.

10. The assembly as recited in claim 9, wherein:
the bore exhibits the second diameter adjacent the second opening, and
the diameter of the bore gradually transitions from the first diameter to the second diameter between the intermediate point and the second opening.

11. The assembly as recited in claim 10, wherein the bore is substantially frustoconically-shaped within the second section.

12. The assembly as recited in claim 1, further comprising a threaded stud projecting through the bore from the second side of the frame and extending beyond the first side of the frame.

13. The assembly as recited in claim 1, wherein:
the bore is one of a plurality of bores of the frame,
the overmolding includes a plurality of second portions, and
each of the second portions are molded over at least a portion of the frame that establishes a respective one of the plurality of bores.

14. The assembly as recited in claim 1, wherein the first portion of the overmolding is molded over substantially an entirety of the first side of the metallic frame.

15. A motor vehicle, comprising:
a body panel; and
a spare tire carrier assembly mounted to the body panel, wherein the spare tire carrier assembly comprises:
a metallic frame including a first side and a second side opposite the first side, wherein the metallic frame includes a bore passing through the metallic frame from the first side to the second side; and
an overmolding including a first portion molded over at least a portion of the first side, and a second portion molded over at least a portion of the bore.

16. The motor vehicle as recited in claim 15, wherein the body panel is configured to open and close relative to a rear opening of the motor vehicle.

17. The motor vehicle as recited in claim 16, wherein the body panel is a panel of a swing gate.

18. The motor vehicle recited in claim 15, wherein:
the bore includes a first opening adjacent the first side of the metallic frame and a second opening adjacent the second side of the metallic frame,
the bore exhibits a first diameter adjacent the first opening and a second diameter adjacent the second opening, and
the second diameter is greater than the first diameter.

19. The motor vehicle as recited in claim 18, wherein the second portion of the overmolding projects into the bore and extends along an entire length of the bore from the first opening to the second opening.

20. A method, comprising:
overmolding a metallic frame of a spare tire carrier assembly, wherein the metallic frame includes a first side and a second side opposite the first side, wherein the metallic frame further includes a bore passing through the metallic frame from the first side to the second side, and wherein the overmolding includes a first portion molded over at least a portion of the first side, and a second portion molded over at least a portion of the metallic frame establishing the bore.
